(19) United States
(12) Patent Application Publication
(10) Pub. No.: US 2021/0132795 A1
(43) Pub. Date: May 6, 2021

(54) SMART MIRROR AND TABLE TOP DEVICES WITH SENSOR FUSION OF CAMERA VISION, ACOUSTIC, AND MULTI-POINT CAPACITIVE TOUCH CONTROL

(71) Applicant: Refliko, Inc., San Francisco, CA (US)

(72) Inventors: Kholida Kurbanova, San Francisco, CA (US); Will Lee, San Francisco, CA (US); Kendall Chow, San Francisco, CA (US)

(73) Assignee: Refliko, Inc., San Francisco, CA (US)

(21) Appl. No.: 17/090,141

(22) Filed: Nov. 5, 2020

Related U.S. Application Data
(60) Provisional application No. 62/930,676, filed on Nov. 5, 2019.

(51) Int. Cl. G06F 3/0488; G06F 3/01; H04N 1/00; G06F 21/32; G06F 3/042; G02B 5/08

(52) U.S. Cl. CPC G06F 3/04886; G06F 3/013; H04N 1/00411; G06F 2203/04804; G06F 3/0425; G02B 5/08; G06F 2203/04803; G06F 21/32

(57) ABSTRACT

Methods and systems are described for providing smart mirror and tabletop devices. In one embodiment, a smart mirror device having a large form factor comprises a storage medium to store software programs and software applications, a capacitive touch control, a display device having a plurality of display modes including first and second modes, and processing logic coupled to the storage medium and the display device. The processing logic is configured to execute instructions of at least one of the software programs or software applications in response to receiving user input from the capacitive touch control.

### CROSS-REFERENCE

This patent application is related to and, under 35 U.S.C. 119, claims the benefit of and priority to U.S. Provisional Patent Application No. 62/930,676, entitled SMART MIRROR AND TABLE TOP DEVICES WITH SENSOR FUSION OF CAMERA VISION, ACOUSTIC, AND MULTI-POINT CAPACITIVE TOUCH CONTROL, by Kholida Kurbanova, et al., filed Nov. 5, 2019, Attorney Docket No. REFLIKO-P001Z, where the contents of which are incorporated herein by reference.

### FIELD OF THE INVENTION

Embodiments of the invention are generally related to smart mirror electronic devices and table top electronic devices having multitouch control to interact, consume and create content.

### BACKGROUND

Current smart mirror devices typically have infrared (IR) touch control to display advertising. These mirror devices having visual bezels to implement the IR touch control. Many of these devices also simply put an existing tablet behind two way glass. This results in a much smaller touch area, and hardware and software cannot be customizable and optimized without full access to the BSP/Kernal.

### SUMMARY

Methods and systems are described for providing smart mirror and tabletop devices. In one embodiment, a smart mirror device comprises a storage medium to store software programs and software applications, a capacitive touch control, a display device having a plurality of display modes including first and second modes, and processing logic coupled to the storage medium and the display device. The processing logic is configured to execute instructions of at least one of the software programs or software applications in response to receiving user input from the capacitive touch control.

Other embodiments are also described. Other features of embodiments of the present invention will be apparent from the accompanying drawings and from the detailed description which follows.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows an embodiment of a perspective view of a smart mirror device 100 having capacitive touch control in accordance with one embodiment.

FIG. 2 shows an embodiment of a frontal view of the smart mirror device 100 having capacitive touch control in accordance with one embodiment.

FIG. 3 shows an embodiment of a side view of the smart mirror device 100 having capacitive touch control 125 in accordance with one embodiment.

FIG. 4 shows an embodiment of a rear view of the smart mirror device 100 having capacitive touch control in accordance with one embodiment.

FIG. 5 illustrates a flow diagram of gaze detect operations for transitioning between display modes of a smart mirror device or tabletop device based on user intent in accordance with certain embodiments

FIG. 6A illustrates that a device can transition from a mirror mode 610 to a device mode 620 or vice versa based on user intent in accordance with one embodiment.

FIG. 6B illustrates 3 users that are close or nearby (e.g., within 10 feet, within 20 feet, within 30 feet) to the device, which is illustrated in a mirror mode with the display being turned off.

FIG. 6C illustrates operation 504 with person 1 gazing towards the device for a threshold time period (e.g., at least 2 seconds, at least 3 seconds, at least 4 seconds).

FIG. 6D illustrates operation 506 with the device switching from mirror mode to device mode.

FIG. 6E illustrates operation 508 with the device remaining in mirror mode when no users are gazing or looking at the device.

FIG. 7 is a block diagram of a wireless smart device 700 (e.g., smart mirror device, smart tabletop device) in accordance with one embodiment.

FIG. 8A illustrates a block diagram for connecting a display panel to a system on chip device board in accordance with one embodiment.

FIG. 8B illustrates a block diagram of a hardware architecture (e.g., 1080p resolution, Full HD) for connecting a display panel to a system on chip device board in accordance with one embodiment.

FIG. 8C illustrates a block diagram of a hardware architecture (e.g., 4K resolution) for connecting a display panel to a system on chip device board in accordance with one embodiment.

FIG. 9 illustrates a tabletop device in accordance with one embodiment.

FIG. 10 illustrates a chest strap device that interacts with a mirror device in accordance with one embodiment.

FIG. 11 illustrates a wireless smart device 1100 (e.g., smart mirror device, smart tabletop device) capturing images of a nearby environment (e.g., indoor area, room) in accordance with one embodiment.

FIG. 12 illustrates image computer vision processing in accordance with one embodiment.

FIG. 13 illustrates an inventory system in accordance with one embodiment.

FIG. 14 illustrates a computer-implemented method (flow diagram) for providing telehealth services in accordance with one embodiment.

### DETAILED DESCRIPTION

Smart mirror and tabletop electronic devices are described having multitouch capacitive control to allow users to interact, consume and create content. These smart electronic devices with a large form factor (e.g., height of at least 4 feet) provide augmented reality for a user to experience software applications (apps) and services with a large human sized screen (e.g., portrait oriented screen for smart mirror device, landscape oriented screen for smart tabletop device) that is significantly larger than existing mobile and tablet devices. In comparison to mobile and tablet devices, a smart mirror and tabletop devices do not need to be held by a user, have improved audio, better microphones due to no size constraint, use as a mirror, and are also considered a furniture centerpiece of a home.

These smart mirror and tabletop devices are bezel-less with a capacitive oleophobic touch interface in contrast to typically IR touch mirror devices. These smart mirror and tabletop devices also have a 3D depth sensing device for enhanced user interaction that allows new experiences in different types of applications (e.g., fitness workouts, video conferencing, telemedicine, Gaming, Education, Point of Sale, Online retail shopping, Clothes/Fashion sales, Cosmetics, Computer Vision applications, Voice assistant technology, Natural Language Processing, Security, Content consumption, Set top box hub, Home hub (e.g., smart home controller), Agnostic to platform in terms of operating with different types of home platforms, and Maps.

In comparison to conventional smart mirrors, the smart mirror and tabletop devices have full CPU/electronics, Camera, Speaker out, Microphone in, Capacitive touch, LCD display or OLED, App store capability, Android APK loadable, ability to display time/weather etc., motion sense, infinite number of apps and services, and landscape orientation for Coffee table device.

These smart mirror and tabletop devices can be utilized as furniture within an indoor environment or a protected outdoor environment. The smart mirror and tabletop devices each have a reflective mode to provide a reflective mirror surface for users. In one example, the smart mirror device provides a full length human sized mirror, standing use (not handheld), and new and novel user experience.

Creators and developers want a life size interactive hardware platform with minimal friction to augment existing solutions and enhance their product experience. The smart mirror device adds telepresence to healthcare, education, hospitality, retail, hospitals, and the home. A user has better remote experiences for their physical and mental well-being with life sized interactive devices.

In this section several embodiments of this invention are explained with reference to the appended drawings. Whenever the shapes, relative positions and other aspects of the parts described in the embodiments are not clearly defined, the scope of the invention is not limited only to the parts shown, which are meant merely for the purpose of illustration.

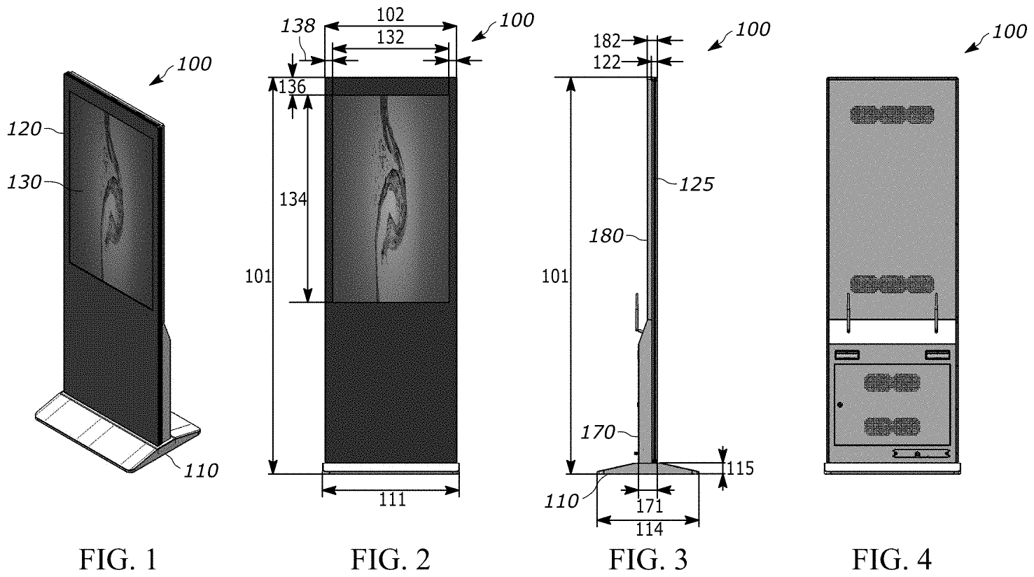

FIG. 1 shows an embodiment of a perspective view of a smart mirror device 100 having capacitive touch control in accordance with one embodiment. The smart mirror device 100 includes a base support 110, a display panel 120 (e.g., 43″, 49″, 55″, 2 k, 4 k, 8 k, OLED, etc.), and a display region 130 having a plurality of display modes including an active mode for using any type of app (e.g., fitness workouts, video conferencing, telemedicine, Gaming, Education, Point of Sale, Online retail shopping, Clothes/Fashion sales, Cosmetics, Computer Vision applications, Voice assistant technology, Natural Language Processing, Security, Content consumption, Set top box hub, Home hub (e.g., smart home controller) and a reflective mirror mode to provide reflectivity of a mirror.

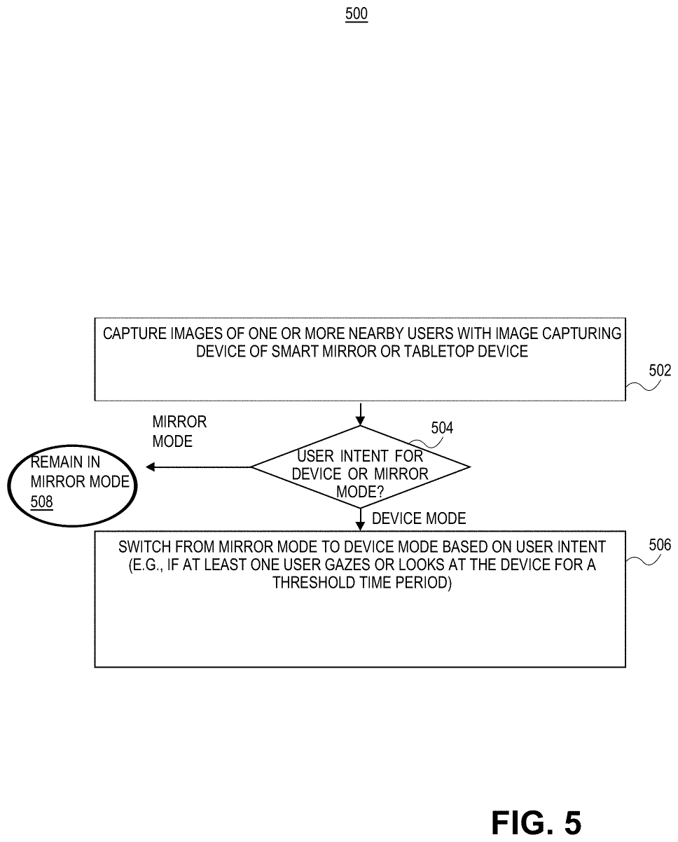

FIG. 2 shows an embodiment of a frontal view of the smart mirror device 100 having capacitive touch control in accordance with one embodiment. In one example, the device 100 has the following dimensions.

The device 100 has a height 101 (e.g., 1600-2000 mm, 60-80 inches), a width 102 (e.g., 500-700 mm, 20-30 inches), base support 110 has a width 111 (e.g., 500-700 mm, 20-30 inches), a display region width 132 (e.g., 500-700 mm, 20-30 inches), a display region height 134 (e.g., 800-1200 mm, 30-50 inches), a width extension 138 (e.g., 20-50 mm, 1-2 inches), and a height extension 136 (e.g., 50-100 mm, 2-4 inches).

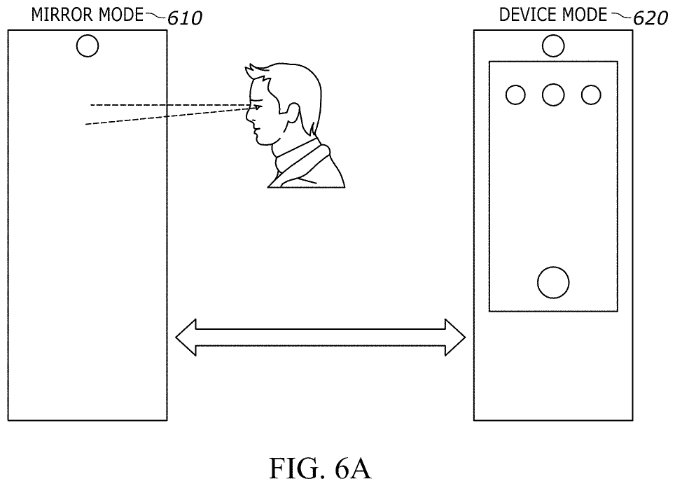

FIG. 3 shows an embodiment of a side view of the smart mirror device 100 having capacitive touch control 125 in accordance with one embodiment. The capacitive touch control 125 can be laminated onto the display panel. In one example, the device 100 has the following dimensions.

The device 100 includes a base support 110, an intermediate support 170, and an upper support 180. The base support has a depth 114 (e.g., 400-500 mm, 15-21 inches) and a height 115 (e.g., 40-60 mm, 1.5-2.5 inches). Intermediate support and display panel have a thickness 171 (e.g., 50-110 mm, 2-4 inches). Upper support and display panel have a thickness 182 (e.g., 40-50 mm, 1.5-2 inches), and display panel has a thickness 122 (e.g., 20-30 mm, 0.75-1.25 inches).

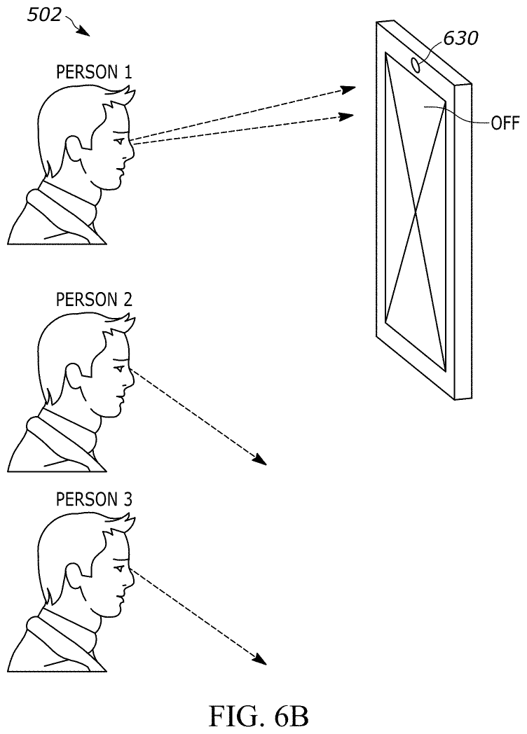

FIG. 4 shows an embodiment of a rear view of the smart mirror device 100 having capacitive touch control in accordance with one embodiment.

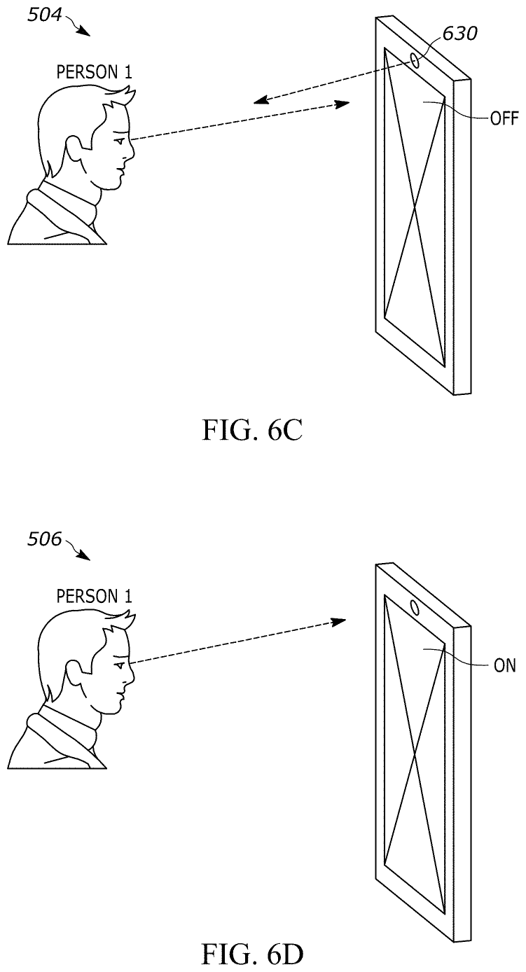

FIG. 5 illustrates a flow diagram of gaze detect operations for transitioning between display modes of a smart mirror device or tabletop device based on user intent in accordance with certain embodiments. The operational flow is performed by a smart electronic device, which includes processing circuitry or processing logic. The processing logic may include hardware (circuitry, dedicated logic, etc.), software (such as is run on a general purpose computer system or a dedicated machine or a device), or a combination of both. In one embodiment, a smart mirror device or smart tabletop device performs the operations of method 500.

At operation 502, a smart mirror or tabletop device having an image capturing device (e.g., camera) captures images of one or more nearby users (e.g., eyes, face). At operation 504, the mirror or tabletop device determines whether a user wants to operate the device in device mode or mirror mode based on user intent. In one example, a user intent is determined based on whether a user is looking at the device for a threshold time period (e.g., at least 2 seconds, at least 3 seconds, at least 4 seconds).

At operation 506, the device switches from mirror mode to device mode if at least one user gazes or looks at the device for a threshold time period. At operation 508, the device remains or continues in mirror mode based on no users gazing or looking at the device for a threshold time period.

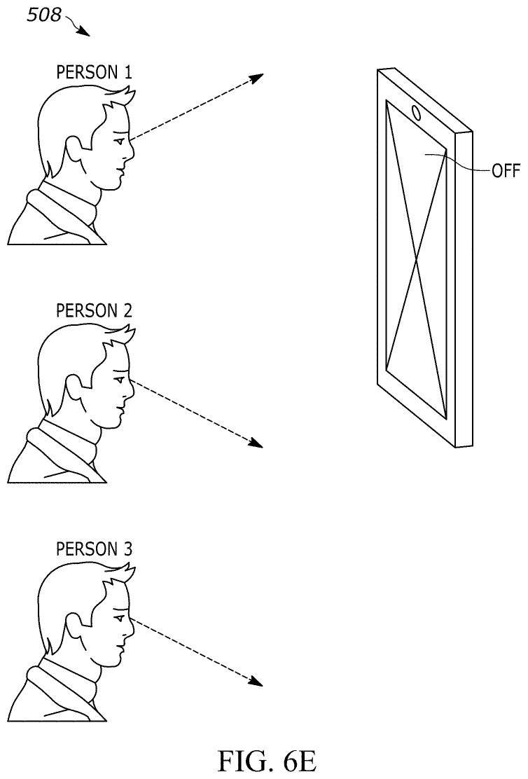

FIGS. 6A-6E illustrate device versus mirror mode and different operations of method 500 in accordance with one embodiment. FIG. 6A illustrates that a device can transition from a mirror mode 610 to a device mode 620 or vice versa based on user intent. FIG. 6B illustrates 3 users that are close or nearby (e.g., within 10 feet, within 20 feet, within 30 feet) to the device, which is illustrated in a mirror mode with the display being turned off. In this example, person 1 is gazing towards the device for a threshold time period (e.g., at least 3 seconds) while persons 2 and 3 are looking in a different direction away from the device (e.g., not gazing towards the device). The device is performing operation 502 and capturing images of persons 1, 2, and 3 with an image capturing device 630 (e.g., camera).

FIG. 6C illustrates operation 504 with person 1 gazing towards the device for a threshold time period (e.g., at least 2 seconds, at least 3 seconds, at least 4 seconds). The device then identifies this person 1 based on a user profile. In one example, the person is identified by capturing images of eyeballs of this person.

FIG. 6D illustrates operation 506 (e.g., gaze detect) with the device switching from mirror mode to device mode. The display panel (e.g., backlight of display panel) turns on based on user intent and identification of the user. Other customizations for the identified user may occur (e.g., initializing a particular app for a user that has been identified by the device). Gaze detect can allow a user to be identified and enter into their chosen app/service. In one example, the gaze detect would not only turn on the mirror to a default app (e.g., app for operating smart mirror device), which would display a time, for example, but the user could choose what that Gaze detect for the user causes to happen during a device mode. For example, upon gaze detect being determined, the user could decide for the mirror device to open up a fitness app, because the user wants to workout right away. Alternatively, gaze detect could cause an app to open that simply shows the clock and weather. In another embodiment, gaze detect causes an application (e.g., social media app, video sharing app, etc.) to open. Within device mode, a user can switch from being within an initializing app to a default display setting or background (e.g., home page) based on touch input (e.g., a virtual touch input anywhere within the app or on capacitive touch control, swipe right with multitouch input (e.g., 2 touch points, 3 touch points, 4 touch points, 5 touch points) within a display region to return to the default display setting or background for the display region.

FIG. 6E illustrates operation 508 with the device remaining in mirror mode when no potential users are gazing or looking at the device. The device transitions from mirror mode to device mode upon a touch anywhere on a capacitive touch control. This cause the backlight to turn on when transitioning from the mirror mode to the device mode.

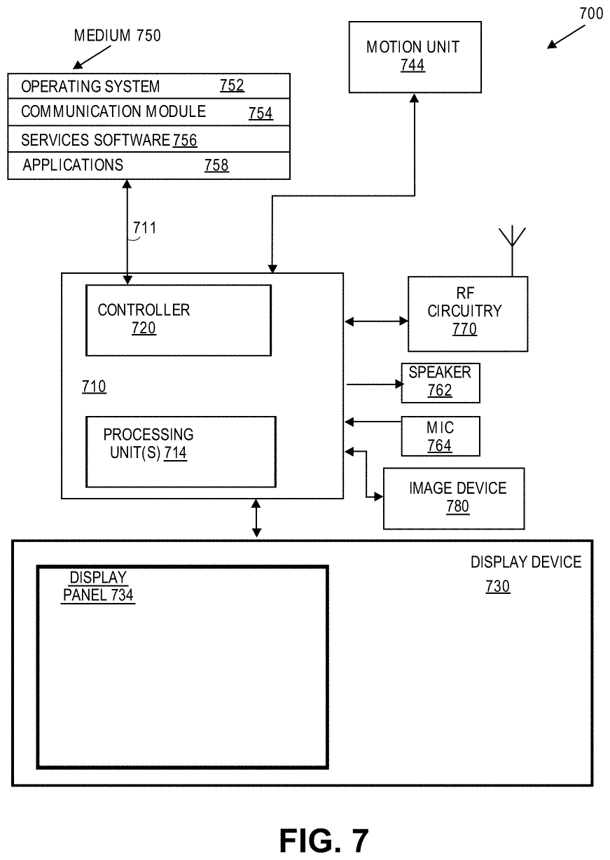

FIG. 7 is a block diagram of a wireless smart device 700 (e.g., smart mirror device, smart tabletop device) in accordance with one embodiment. The wireless device 700 includes a processing system 710 (e.g., SoC) that includes a controller 720 and processing units 714 (e.g., CPU). The processing system 710 communicates with a display device 730, radio frequency (RF) circuitry 770, speaker 762, mic 764, an image capturing device 760 (e.g., 1080p Front camera, 5 MP) for capturing one or more images or video, a motion device 744 (e.g., an accelerometer, gyroscope) for determining motion data (e.g., in three dimensions, 6 axis, etc.) for the wireless device 700, and machine-accessible non-transitory medium 750 (e.g., RAM, any type of memory). These components are coupled by one or more communication links or signal lines.

RF circuitry 770 is used to send and receive information over a wireless link or network to one or more other devices. RF circuitry 770 can include BlueTooth, WiFi, and cellular (e.g., 5G) modules (e.g., A2DP/HFP). Optionally, the device 700 may also include a wired network connection (e.g., Ethernet).

The processing system communicates with one or more machine-accessible non-transitory mediums 750 (e.g., computer-readable medium). Medium 750 can be any device or medium (e.g., storage device, storage medium) that can store software code and data for use by one or more processing units 714. Medium 750 can include cache, main memory and secondary memory. The medium 750 stores one or more sets of instructions embodying any one or more of the methodologies or functions described herein. The software may include an operating system 752, mirror or tabletop services software 756 for operations of the smart mirror or tabletop device discussed herein, communications module 754, and applications 758 (e.g., publisher applications, developer applications, a web browser, html5 applications, etc.). The software may also reside, completely or at least partially, within the medium 750 or within the processing units 714 during execution thereof by the device 700. The components shown in FIG. 7 may be implemented in hardware, software, firmware or any combination thereof, including one or more signal processing and/or application specific integrated circuits.

Communication module 754 enables communication with other devices. The processing system communicates with display device 730 (e.g., a display, a liquid crystal display (LCD), a plasma display, capacitive touch display device 734 with multipoint touch (e.g., 2 point touch, 5 point touch, 10 point touch), or touch screen for receiving user input and displaying output, an optional alphanumeric input device) having a display panel 734.

In one example, the mirror and tabletop devices have software (e.g., Android based software) and will allow a user to load apps by accessing an app store (e.g., Play store, any app store). An image capturing device 780 may include a standard camera, a 3D Depth camera that allows a user to interact with the device 700 based on gesturing from a certain distance away (e.g., 1-20 ft) from the device 700. The device 700 is designed with an App store that is specific to the hardware of the device. The device 700 has over the air (OTA) capability to update software. The image capturing device or other sensors can sense user motion and intent to detect whether to turn on/off a backlight of the display device to transition from pure mirror mode (e.g., reflection mode) to electronic mode. The display device may include an Oleophobic/Hydrophobic coating for less fingerprint, and smoother swipes. In one example, the device 700 includes a power plug but does not include a battery source.

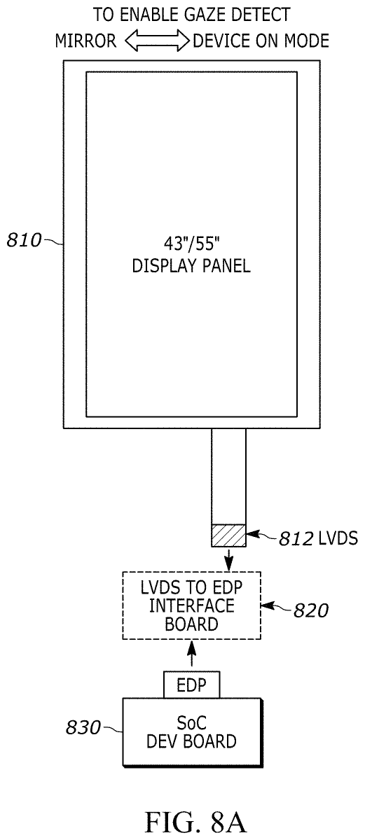

FIG. 8A illustrates a block diagram for connecting a display panel to a system on chip device board in accordance with one embodiment. A capacitive touch display panel 810 (e.g., 43 inch diagonal, 55 inch diagonal) has a low-voltage differential signaling (LVDS) interface 812 that connects to LVDS to embedded display port (EDP) interface board 820 and this board 820 is coupled to EDP interface of device board 830. These connections between the display panel and the device board enable gaze detection for determining user intent and switching the device from mirror mode to device mode.

FIG. 8B illustrates a block diagram of a hardware architecture (e.g., 1080p resolution, Full HD) for connecting a display panel to a system on chip device board in accordance with one embodiment. The hardware architecture 850 includes mirror glass 852, a display panel 854 (e.g., 43″/55″ 1920×1080p, 43″/55″ 3840×2160p) with capacitive touch, a virtual power button 856, a system on chip (SoC) 858, a camera 860 (e.g., 5 MP), an omni-directional microphone 862 that is positioned a certain distance (e.g., 18″) from the processing system 858 (e.g, SoC 858), and speakers 863-864. The components of this hardware architecture are connected with wired or wireless connections 865-870. In one example, connection 865 is a MIPI connection, connection 866 is an USB connection, and connection 868 is a LVDS connection. The LVDS connection 868 minimizes delay between receiving a user touch input on the display panel and the SoC receiving this input and being able to process and respond to this input to provide an improved user experience and interaction with the display panel of the smart mirror device.

FIG. 8C illustrates a block diagram of a hardware architecture (e.g., 4K resolution) for connecting a display panel to a system on chip device board in accordance with one embodiment. The hardware architecture 880 includes mirror glass 882, a display panel 884 (e.g., 43″/55″ 3840×2160p) with capacitive touch, a virtual power button 886, a processing system 888 (e.g., system on chip (SoC) 888), a camera 890 (e.g., 5 MP), an omni-directional microphone 891 that is positioned a certain distance (e.g., 18″) from the SoC 888, and speakers 892-893. The components of this hardware architecture are connected with wired or wireless connections 894-899. In one example, connection 894 is a MIPI connection, connection 895 is an USB connection, and connection 897 is a Vx1(V by One) connection. The connection 897 minimizes delay between receiving a user touch input on the display panel and the SoC receiving this input and being able to process and respond to this input to provide an improved user experience and interaction with the display panel of the smart mirror device.

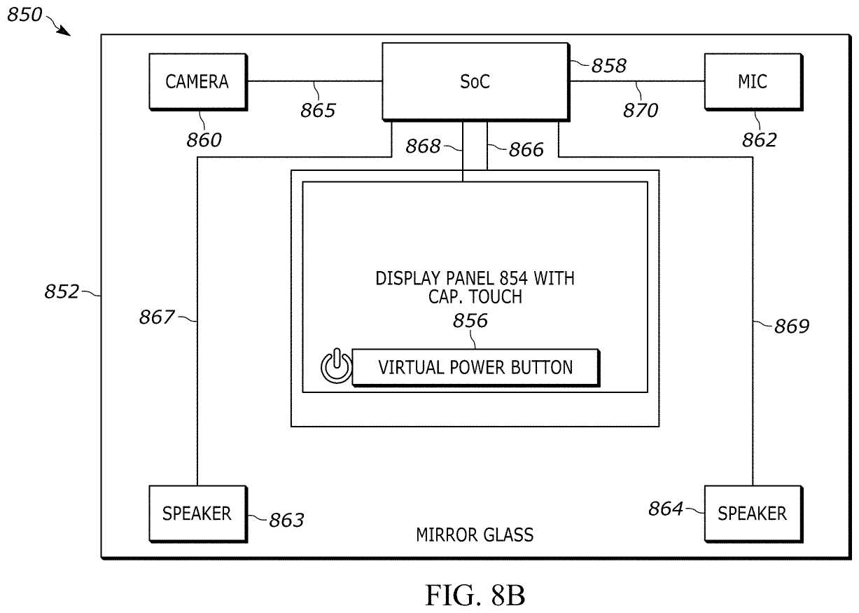

FIG. 9 illustrates a tabletop device in accordance with one embodiment. The smart tabletop device 900 includes a capacitive touch display panel 910 and table legs 911-914. The tabletop device includes WiFi and BlueTooth modules, speakers, microphone, camera, and power plug.

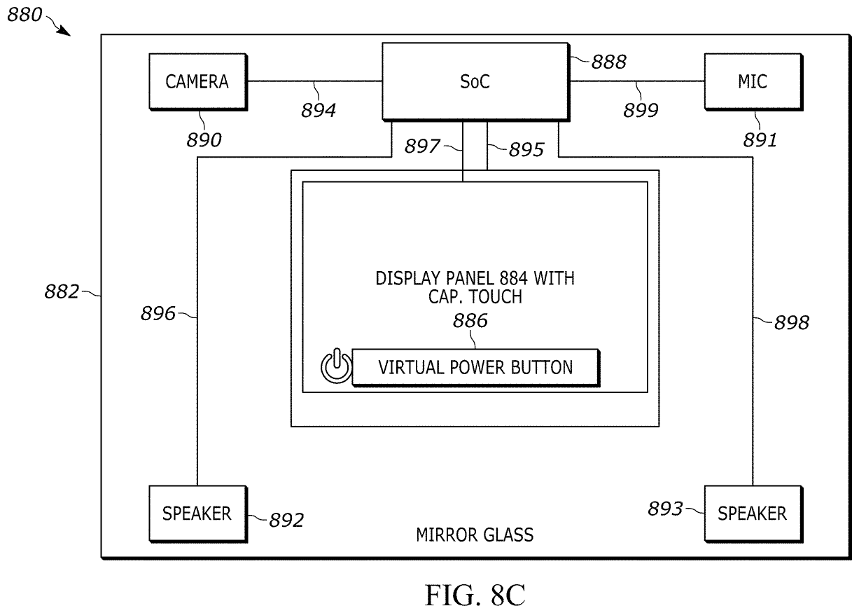

FIG. 10 illustrates a chest strap device that interacts with a mirror device in accordance with one embodiment. A user can wear a chest strap device 1002 for fitness applications that are displayed by the mirror device. The chest strap device can be battery operated, have a wireless mode (e.g., BlueTooth) for communicating with the mirror device 1010, and also include sensors (e.g., IMU, accelerometer, EKG) for measuring different biometrics of a user including heartrate, cardiac electrical potential waveforms, etc. A user can be identified by the mirror device based on capturing images of the user, matching images with user profile, or measuring a unique EKG heartrate when the user is wearing the chest wearable device.

In one example, upon identifying and authenticating the user based on receiving data from the chest wearable device, the mirror device can provide feedback to the user (e.g., did you work out, real time monitoring during fitness workout, application of fitness data to provide recommendations to the user, etc.).

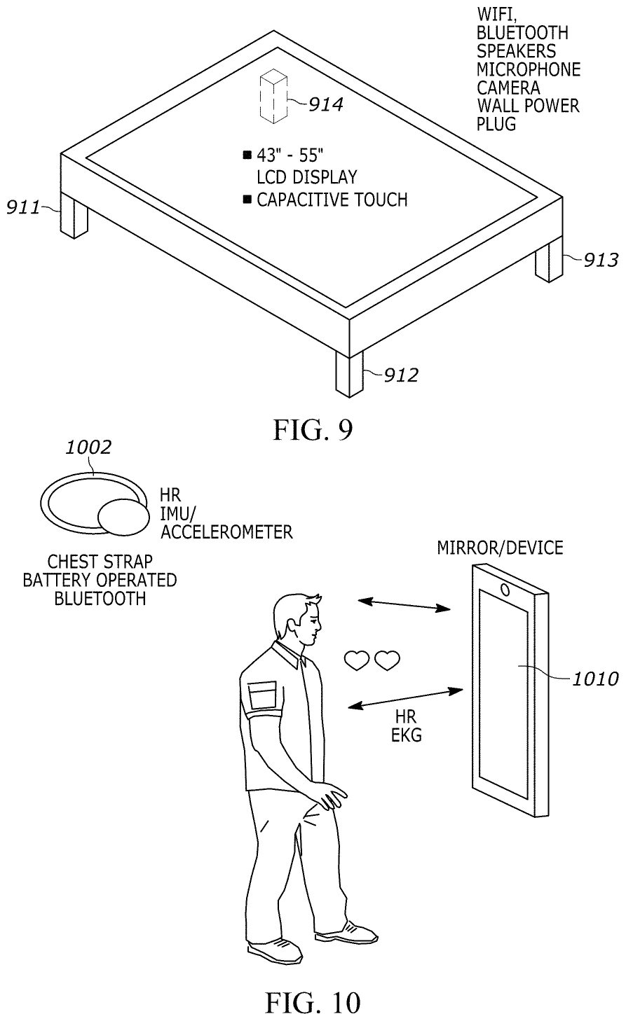

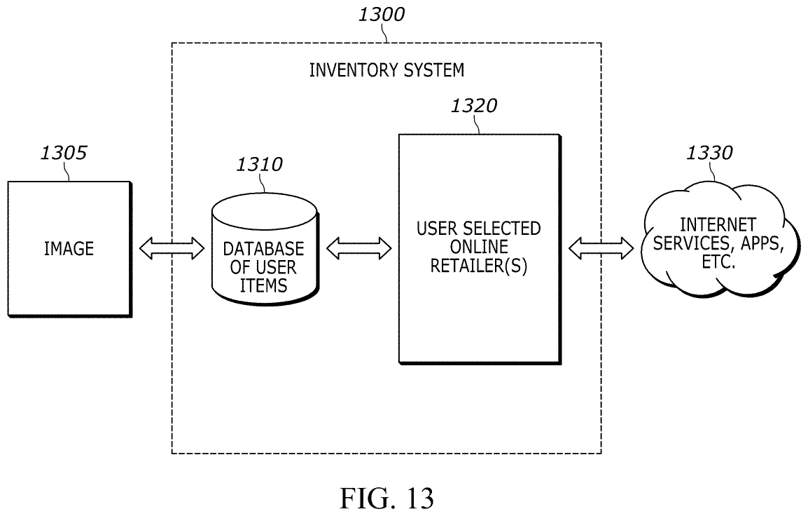

FIG. 11 illustrates a wireless smart device 1100 (e.g., smart mirror device, smart tabletop device) capturing images of a nearby environment (e.g., indoor area, room) in accordance with one embodiment. A smart device 1100 includes a camera 1110 to capture images of an area 1120 that includes different objects. In one example, images of a living room are captured. Users use an app that is associated with the smart device to take selfie photos or video conference. In this process, a database is allowed to store images of an image capturing session. An inventory system 1300 is able to store the images 1305 and generate a database 1310 of user items based on these images as illustrated in FIG. 13 in accordance with one embodiment.

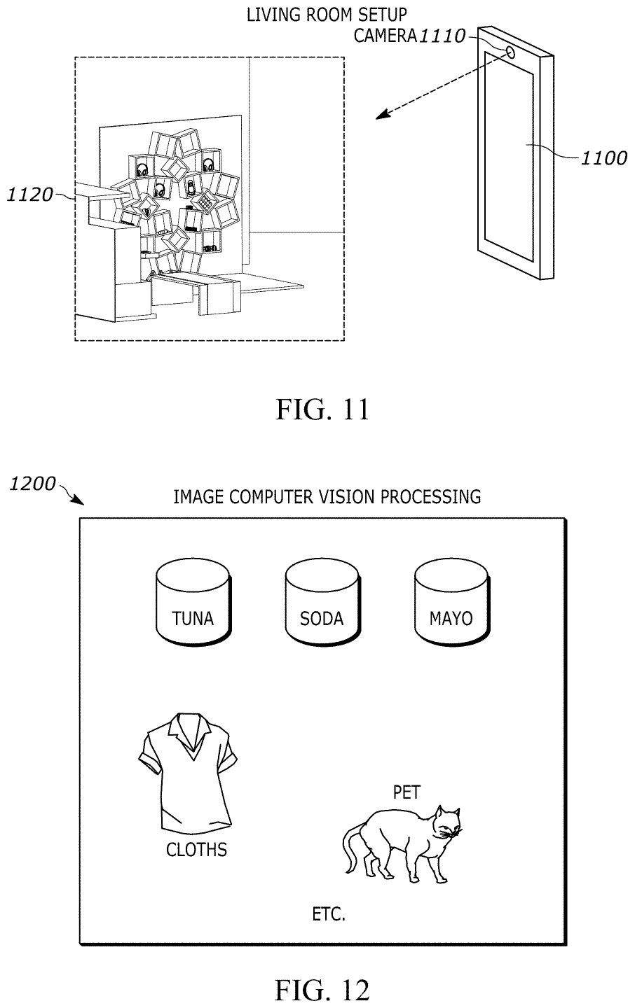

FIG. 12 illustrates image computer vision processing in accordance with one embodiment. In this image computer vision processing 1200, computer vision and machine learning are used to analyze the captured images to identify objects in a background of an area or room. These objects can be categorized but not limited to food items, pets, etc. This can also be done in a more detailed manner to the exact stock keeping unit (SKU) or identifier of a product. This can also determine when an item is running low, and is a highly desired item for the user, for example milk, eggs, beverage, etc.

Referring to FIG. 13, the inventory system 1300 stores user item data that is obtained from the image computer vision and tracks a status (e.g., full condition, partial condition, low condition) of user items (e.g., milk, eggs, pet food, etc.) for the user, with their permission. At operation 1320, the user could then choose a default or preferred online ecommerce retailer. An item having a low condition can be ordered automatically or voluntarily based on a determined status of the item. The inventory system is communicatively coupled to a network 1330 (e.g., Internet, local area network, wide area network, etc.) to communicate with the user's smart wireless device (e.g., mirror device, table top device) and to communicate with 3^{rd} parties (e.g., online retailers).

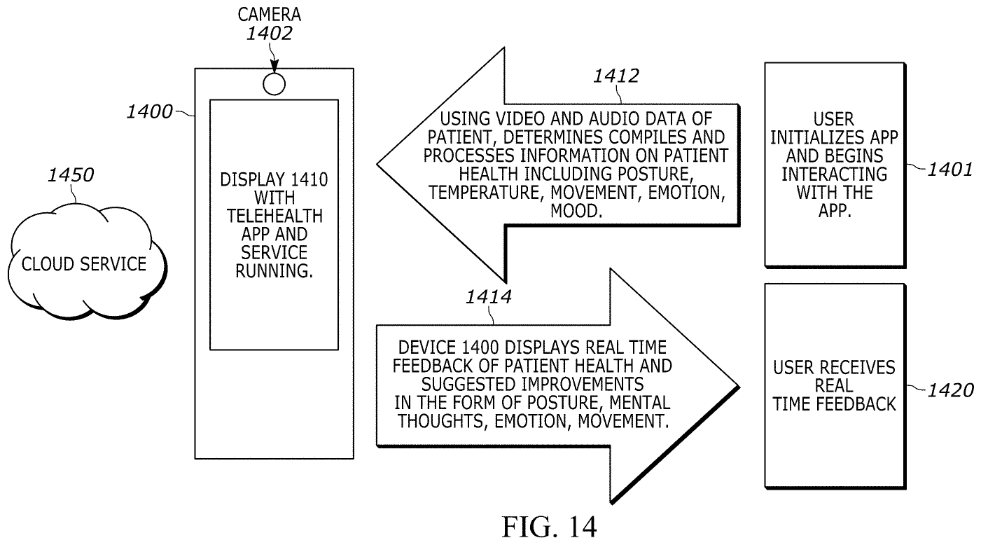

FIG. 14 illustrates a computer-implemented method (flow diagram) for providing telehealth services in accordance with one embodiment. At operation 1401, a user initializes an app (e.g., telehealth app) on the smart mirror device and begins interacting with the app. In one example, a user is able to have a video call with a physical therapist (PT) or medical professional. The user performs different exercises and stretches during the video call. The smart mirror device 1400 has a camera 1402 to capture images including video data of the user and also includes a microphone to capture audio data from the user. The display 1410 can display the PT or medical professional, images of exercises and stretches to be performed by the user, or real time images of the user during the exercises or stretches. At operation 1412, the smart mirror device obtains the video and audio data of the user. The smart mirror device or a remote cloud service 1450 in communication with the smart mirror device can use the video and audio data of the user to determine, compile, and process information on user health including posture, temperature, movement, emotion, and mood. At operation 1414, the device 1400 displays real time feedback of user health and also suggests improvements in the form of at least one of posture, mental thoughts, emotion, and movement.

The smart mirror device provides full body lifesize images of the user to the PT or medical professional to improve feedback provided to the user. The smart mirror device also allows the user to see her/his reflection so it helps with her/his communication to the health provider. The cameras and audio through this format gather the patients behavior in the lifesize format, which otherwise would only be shoulder and up for conventional devices such as smart phones or laptops.

In one embodiment, a machine-accessible non-transitory medium contains executable computer program instructions which when executed by a data processing system cause the system to perform any of the methods discussed herein. While the machine-accessible non-transitory medium 750 is shown in an exemplary embodiment to be a single medium, the term “machine-accessible non-transitory medium” should be taken to include a single medium or multiple media (e.g., a centralized or distributed database, and/or associated caches and servers) that store the one or more sets of instructions. The term “machine-accessible non-transitory medium” shall also be taken to include any medium that is capable of storing, encoding or carrying a set of instructions for execution by the machine and that cause the machine to perform any one or more of the methodologies of the present invention. The term “machine-accessible non-transitory medium” shall accordingly be taken to include, but not be limited to, solid-state memories, optical and magnetic media, and carrier wave signals.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A smart mirror device having a large form factor, comprising:
a storage medium to store software programs and software applications;
a capacitive touch control;
a display device having a plurality of display modes including first and second modes; and
processing logic coupled to the storage medium and the display device, the processing logic is configured to execute instructions of at least one of the software programs or software applications in response to receiving user input from the capacitive touch control of the smart mirror device having the large form factor.

2. The smart mirror device of claim 1, wherein the first mode comprises a reflective mirror mode and the second mode comprises an active device mode to display a plurality of software applications.

3. The smart mirror device of claim 2, wherein the processing logic is further configured to switch from the first mode to the second mode based on receiving a user input from the capacitive touch control.

4. The smart mirror device of claim 2, wherein the processing logic is further configured to switch from the first mode to the second mode based on determining user intent of a user in close proximity to the smart mirror device

5. The smart mirror device of claim 1, wherein the smart mirror device is bezel-less with a capacitive oleophobic touch interface.

6. The smart mirror device of claim 1, further comprising:
a base support that has a width of 20-30 inches;
an intermediate support with a thickness of 2-4 inches; and
an upper support having a thickness of 1.5 to 2 inches.

7. The smart mirror device of claim 1, wherein the display device comprises a display panel having a thickness of 0.75 to 1.25 inches.

8. The smart mirror device of claim 1, wherein the smart mirror device having the large form factor has a height of 60 to 80 inches and a width of 20 to 30 inches.

9. The smart mirror device of claim 1, further comprising:
a camera to capture images of an area that includes different objects of a user.

10. The smart mirror device of claim 9, wherein the processing logic is configured to store the captured images in the storage medium, to generate a database of user items based on these images, to analyze the captured images to identify items in the area, and to categorize these items.

11. The smart mirror device of claim 10, wherein the processing logic is further configured to track a status including full, partial, or low condition for the items, and to automatically order the item based on the status and determining a product identifier for the item to be ordered from an application.

12. A computer-implemented method for gaze detection, comprising:
capturing, with a smart mirror or tabletop device having an image capturing device, images of one or more nearby users;
determining, with the smart mirror or tabletop device, whether any nearby user intends to operate the smart mirror or tabletop device in a device mode or a mirror mode based on user intent.

13. The computer-implemented method of claim 12, wherein the user intent is determined based on whether a user is looking at the smart mirror or tabletop device for a threshold time period.

14. The computer-implemented method of claim 12, further comprising:
switching from the mirror mode to the device mode if at least one user gazes or looks at the smart mirror or tabletop device for a threshold time period.

15. The computer-implemented method of claim 12, wherein the smart mirror or tabletop device remains or continues in the mirror mode based on no users gazing or looking at the device for a threshold time period.

16. The computer-implemented method of claim 12, wherein the smart mirror or tabletop device identifies a user based on a user profile with the user being identified by capturing images of facial features or eyes of this users.

17. The computer-implemented method of claim 16, wherein the smart mirror or tabletop device provides customizations for the identified user by initializing a particular application for the identified user.

18. The computer-implemented method of claim 12, wherein for device mode, a user can switch from being within an initializing application to a default display setting within a display region based on touch input within the display region to return to the default display setting.

19. A computer-implemented method comprising:
initializing an application on a smart mirror device having capacitive touch control and a large form factor in response to a user input being received by the smart mirror device; and
capturing, with the smart mirror device, images including video data of the user and also capturing audio data while the user interacts with the initialized application.

20. The computer-implemented method of claim 19, wherein the smart mirror device adds a telepresence to healthcare, education, hospitality, retail, hospitals, and a user's home.

21. The computer-implemented method of claim 19, wherein the large form factor of the smart mirror device comprises a height of at least four feet.

22. The computer-implemented method of claim 19, further comprising:
processing, with the smart mirror device or a remote cloud service in communication with the smart mirror device, the video and audio data of the user to determine at least one of posture, temperature, movement, emotion, and mood for the user.
displaying, with the smart mirror device, real time feedback of user health and also suggesting improvements in the form of posture, mental thoughts, emotion, and movement.
